(19) United States
(12) Patent Application Publication
(10) Pub. No.: US 2009/0255386 A1
(43) Pub. Date: Oct. 15, 2009

(54) Torque Socket

(76) Inventor: Jyun-Wun LIAO, Taichung City (TW)

Correspondence Address: Dr. BANGER SHIA, 102 Lindencrest Ct., Sugar Land, TX, 77479-5201, US

(21) Appl. No.: 12/422,556

(22) Filed: Apr. 13, 2009

(30) Foreign Application Priority Data
Apr. 14, 2008 (TW) 097113531

(51) Int. Cl. B25B 23/143; B25B 23/157; B25B 13/06

(52) U.S. Cl. 81/474; 81/480; 81/124.5

(57) ABSTRACT

A torque socket essentially comprises an inner socket, and an outer socket. Besides a function of torque value setting and adjustment, the torque socket utilizes a ratchet structure design to produce a sound to warn the user, when the torque applied by the torque socket has reached a predetermined value, allowing the user to know the torque applied to the fastener by the torque wrench has reached the predetermined value easily. Further, the torque socket is simple in structure, thus reducing the production and assembly cost.

### BACKGROUND OF THE INVENTION

1. Field of the Invention

The present invention relates to a wrench, and more particularly to a torque socket.

2. Description of the Prior Art

A conventional socket is normally mounted on a power tool or wrench to screw or unscrew a fastener, and the screwing or unscrewing force is manually controlled by the user. Too large force will cause damage to the fastener, and too small force may cause looseness of the fastener.

To solve the abovementioned drawbacks, normally, the socket is structurally designed to have a predetermined value which prevents the inappropriate force caused deadlock or looseness of the fastener.

For example, GB Patent No. 856136 discloses torque limiting wrench which comprises three smaller balls abutted against the lower end of a larger ball, an elastic member vertically pressing against the larger ball, and a cylindrical housing defined with slots for receiving the smaller balls. These parts cooperate with one another to screw and unscrew a fastener. However, the cylindrical housing is brought into contact with the smaller balls by smooth arc surfaces, in other words, there is no ratchet structure in the cylindrical housing, so that when the torque wrench is operated, it is too difficult to detect if the toque applied to the fastener by the torque wrench has reached the predetermined value, thus needing improvement. In addition, the torque wrench needs to be defined with multiple holes to cooperate with the respective elements, such as the larger ball, the three smaller balls, the elastic member, etc. Furthermore, the respective elements need to be produced independently, and it also requires holding spaces to be formed to hold the elements, so the production difficulty and cost are increased.

Further, U.S. Pat. No. 3,693,381 discloses torque responsive clutch which comprises a larger central ball under a predetermined spring pressure, three smaller balls abutted against the lower end of the larger central ball, and a hosing with six identical recesses. With these parts, the output torque of the wrench can be detected in time during the operation of the torque clutch. However, such a conventional torque responsive clutch also has the above drawbacks of difficult to detect if the toque applied to the fastener by the torque wrench has reached a predetermined value, complicated machining procedure, and high production difficulty and cost.

GB Patent No. 2180476 discloses quick change adapter with a torque limiter for a tapping chuck which comprises a tap holder, a driving element, a casing and an inner toque means. These parts cooperate with one another to allow the fastener to be appropriately screwed or unscrewed. However, the torque means includes plural pairs of balls that cooperate with a plain washer and plural Belleville type springs, the torque limiter need to be defined with multiple holes to cooperate with the respective elements, thus increasing assembly difficulty and the production cost.

In addition, U.S. Pat. No. 4,063,474 discloses torque limiting screwdriver which essentially comprises a sliding sleeve, a torque adjusting rod and a torque adjusting means therein. The torque adjusting means includes plural balls, a clutch and plural springs. Since the configuration is complicated, multiple holes need to be defined to cooperate with the respective elements, and the respective elements need to be produced independently, and it also requires holding spaces to be formed to hold the elements, the production difficulty and cost of the torque socket are greatly increased. Further, it is also too difficult to detect if the torque applied to the fastener by the torque wrench has reached a predetermined value, so improvement is also needed.

Finally, U.S. Pat. No. 4,272,973 discloses socket joint for torque wrench which is orderly provided with a first engaging element, a second engaging element to be engaged with the first engaging element, a spring pressing against the second engaging element and an adjusting bolt pressing against the spring in a housing. When the toque joint is in use, once the force applied by the spring to the second engaging element is insufficient, idle rotation of the second engaging element will be caused, and the torque joint will become ineffective.

The present invention has arisen to mitigate and/or obviate the afore-described disadvantages.

### SUMMARY OF THE INVENTION

The primary objective of the present invention is to provide a torque socket, which utilizes an inner ratchet structure to produce a sound when the torque has reached a predetermined value, allowing the user to easily detect that the torque applied by the torque wrench to the fastener has reached the predetermined value.

The secondary objective of the present invention is to provide a torque socket which is simple in structure, thus reducing the production and assembly cost.

Hence, in order to achieve the above objectives, a torque socket in accordance with the present invention comprises an inner socket and an outer socket. The inner socket is interiorly provided with an axially movable positioning ball, a spring and a radially movable loading ball, the positioning ball and the loading ball are pushed against each other, and the loading ball is allowed to partially protrude out of the inner socket.

The outer socket axially includes a holding groove in one end thereof, the holding groove of the outer socket is formed with a ratchet surface on an inner periphery thereof, on the ratchet surface is equidistantly provided plural annularly-arranged teeth, the respective teeth include two side surfaces, and a resisting surface connected between the two side surfaces, between two opposite side surfaces of each two neighboring teeth is formed a U-shaped engaging recess with respect to the ratchet surface, the outer socket is allowed to be pivotally engaged on the inner socket, when the loading ball is engaged into the one of the engaging recesses, the outer socket and the inner socket will be fixed relative to each other, when the loading ball is pushed against by one of the resisting surfaces of the teeth, the outer socket and the inner socket are allowed to pivot relative to each other.

By such arrangements, during a pivoting process of the inner socket and outer socket, the loading ball will move into and out of the inner socket due to its position changes with respect to the engaging recesses and the teeth, and when the loading ball passes over the teeth and engages into the engaging recess, a sound will be produced.

### BRIEF DESCRIPTION OF THE DRAWINGS

FIG. 1 is an exploded view of a torque socket in accordance with the present invention;

FIG. 2A is a cross-sectional view showing an operating state of the torque socket in accordance with the present invention;

FIG. 2B is a cross-sectional view along the line 2B-2B of FIG. 2A, showing the operating state of the torque socket in accordance with the present invention;

FIG. 3A is a cross-sectional view showing a non operating state of the torque socket in accordance with the present invention;

FIG. 3B is a cross-sectional view along the line 3B-3B of FIG. 3A, showing the non operating state of the torque socket in accordance with the present invention;

FIG. 4 is a perspective view showing the torque socket in accordance with the present invention is engaged with different tool heads;

FIG. 5 is a perspective view showing the torque socket in accordance with the present invention is assembled to a wrench;

FIG. 6 is a perspective view showing the torque socket in accordance with the present invention is assembled to a gripping handle;

FIG. 7 is a cross sectional view shown how the adjusting rod for the torque socket in accordance with the present invention is adjusted;

FIG. 8 is a perspective view showing that the torque socket in accordance with the present invention is engaged with a sleeve;

FIG. 9 is an exploded view showing another torque socket in accordance with the present invention is not provided with an adjusting rod; and

FIG. 10 is a cross sectional view of the torque socket in accordance with the present invention of FIG. 9.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

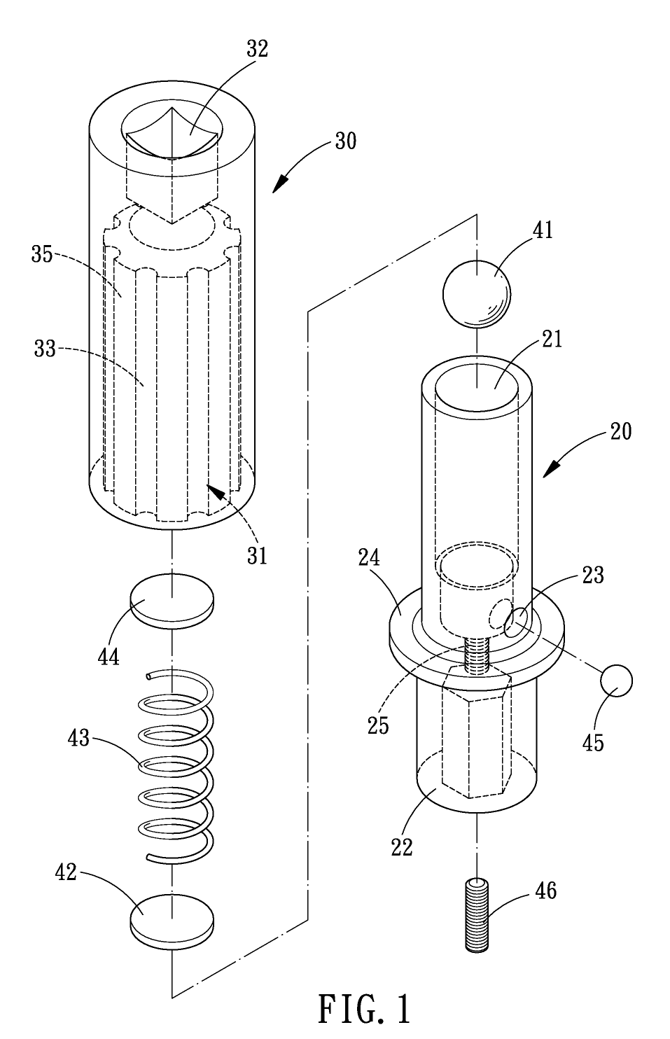

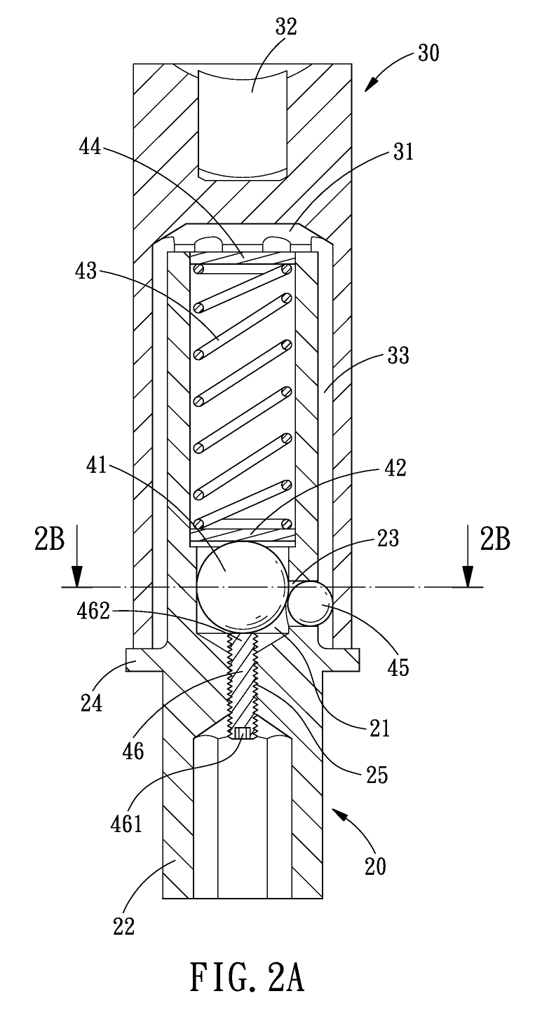

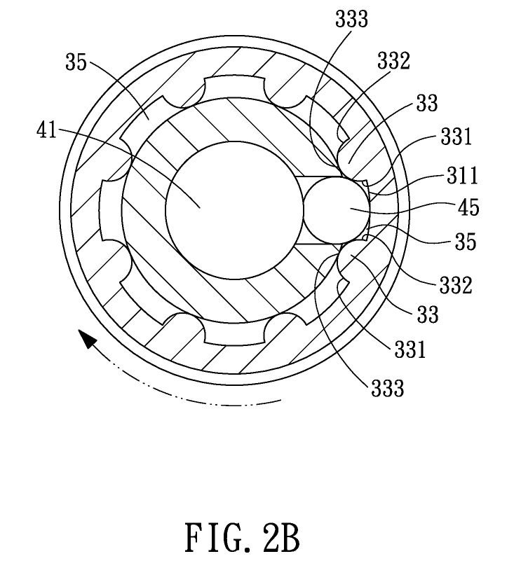

Referring to FIGS. 1, 2A and 2B, a torque socket in accordance with a first embodiment of the present invention essentially comprises an inner socket 20 and an outer socket 30 that are allowed to pivot relative to each other after being assembled.

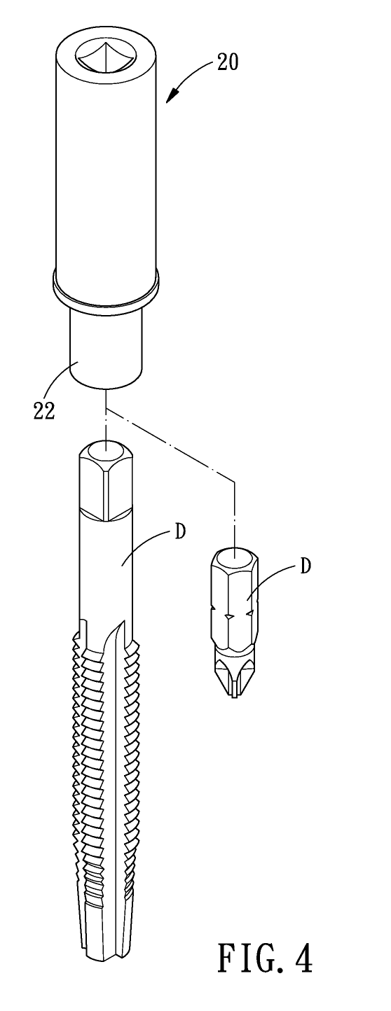

The inner socket 20 axially includes a recess 21 and a first assembling portion 22 in two opposite ends thereof. The inner socket 20 is radially defined with a through hole 23 in communication with the recess 21. Further, the inner socket 20 is formed with a flange 24 radially extending outwards from a middle portion thereof. In addition, between the recess 21 and the first assembling portion 22 is axially defined a threaded adjusting hole 25. A positioning ball 41, a first stopper 42, a spring 43 and a second stopper 44 are orderly disposed in the recess 21 and abutted against one another. The first assembling portion 22 is an inner tetragonal or hexagonal groove for engaging with a tool head D (as shown in FIG. 4). In the through hole 23 is disposed a loading ball 45. The positioning ball 41 and the loading ball 45 are pushed against each other, and the loading ball 45 is allowed to partially protrude out of the inner socket 20. In the adjusting hole 25 is disposed an adjusting rod 46 which can be axially adjusted. The adjusting rod 46 is in the form of a screw, and one end 461 of the screw 46 protrudes out of the first assembling portion 22 for the user to adjust the depth that the adjusting rod 46 is screwed into the adjusting hole 25, thus providing a function of value setting and adjustment. The other end 462 of the adjusting rod 46 is abutted against the positioning ball 41.

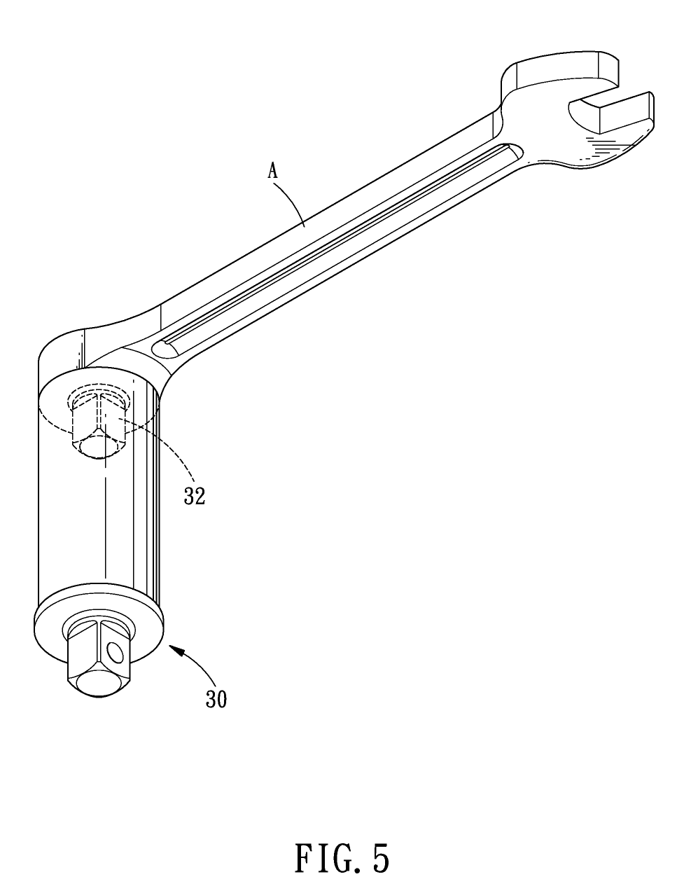

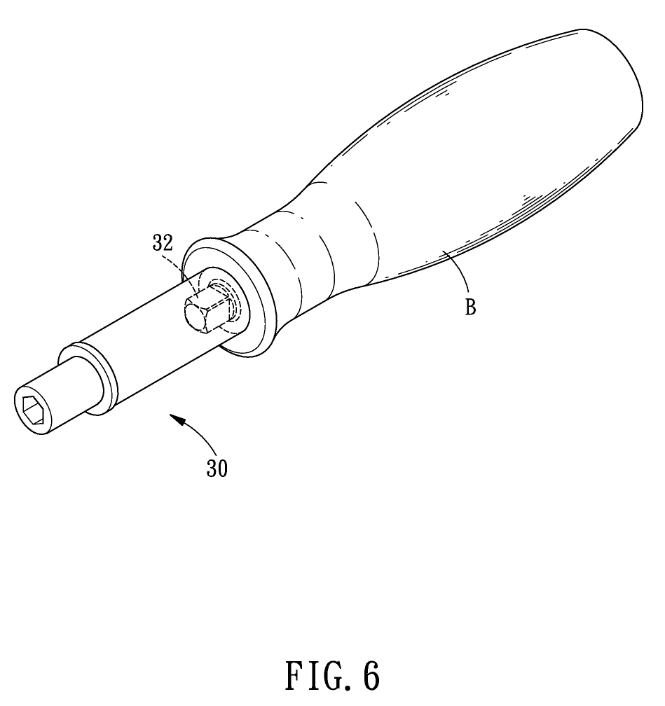

The outer socket 30 axially includes a holding groove 31 and a second assembling portion 32 at two ends thereof. The second assembling portion 32 is provided for engaging with hand tools such as a wrench A or a gripping handle B (as shown in FIGS. 5 and 6). The holding groove 31 is formed with a ratchet surface 311 on an inner periphery thereof, and on the ratchet surface 311 are equidistantly provided annularly-arranged plural teeth 33. The respective teeth 33 include a first side surface 331, a second side surface 332, and a resisting surface 333 connected between the first side surface 331 and the second side surface 332. Between each two neighboring teeth 33 is formed a U-shaped engaging recess 35 with respect to the ratchet surface 311, namely two opposite side surfaces of each two neighboring teeth 33 and the ratchet surface 311 define a U-shaped engaging recess 35. The outer socket 30 can be pivotally engaged on the inner socket 20. When the outer socket 30 and the inner socket 20 are assembled, the outer socket 30 will be stopped against the flange 24, so that when the loading ball 45 is engaged into one of the engaging recesses 35, the inner socket 20 and the outer socket 30 will be fixed relative to each other, and when the loading ball 45 is pushed against by one of the resisting surfaces 333 of the teeth 33, the inner socket 20 and the outer socket 30 are allowed to pivot relative to each other.

By such arrangements, during the pivoting process of the inner socket 20 and outer socket 30, the loading ball 45 will move into and out of the inner socket 20 due to its position changes with respect to the engaging recesses 35 and the teeth 33, and when the loading ball 45 passes over the teeth 33 and engages into the engaging recess 35, a sound will be produced.

The aforementioned is the key technology and the summary of the positional and structural relationship of the respective components of the preferred embodiment in accordance with the present invention.

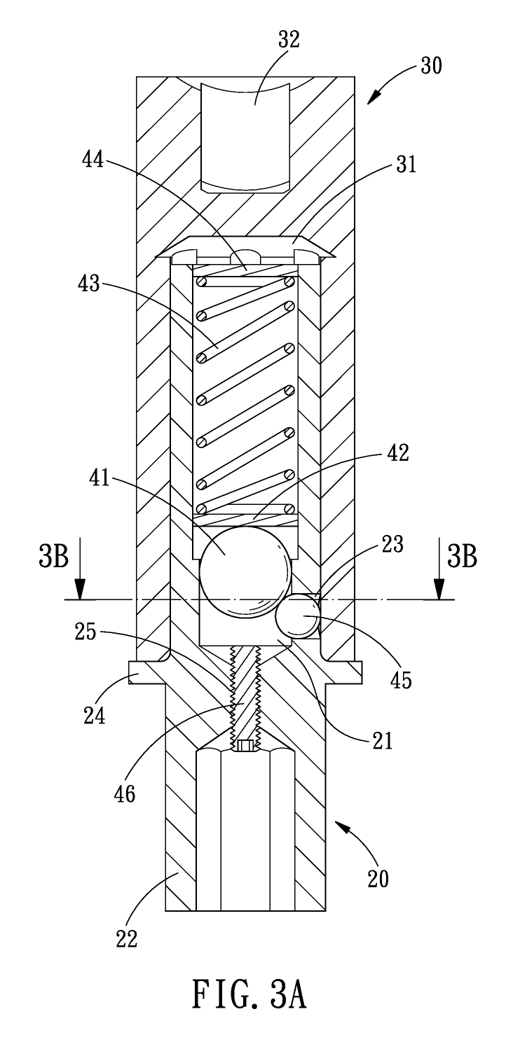

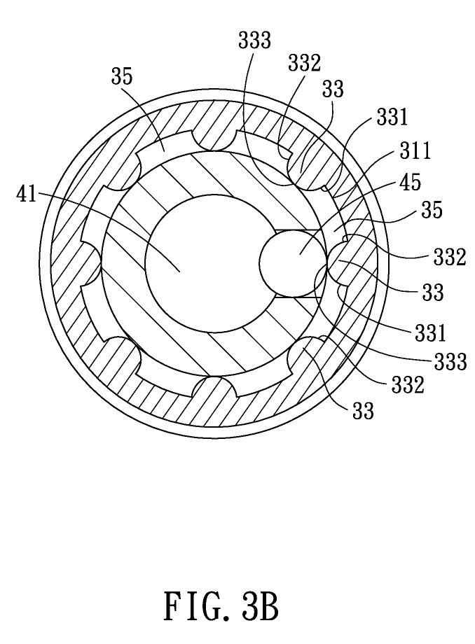

For a better understanding of the present invention, its operation and function, reference should be made to FIGS. 2A and 2B and FIGS. 3A and 3B again.

When the torque applied to the torque socket during operation is lower than the value preset by the user, the torque socket can be used to screw or unscrew the fastener due to secure engagement between the loading ball 45 and one of the engaging recesses 35 of the outer socket 30.

When the torque applied to the torque socket during operation is greater than the value preset by the user, the outer socket 30 can be rotated in a clockwise direction to allow the loading ball 45 to retract into the through hole 23 of the inner socket 20 along the first side surface 331 and the resisting surface 333 of one of the teeth 33 of the outer socket 30. At this moment, the loading ball 45 will push the positioning ball 41 to ascend a certain distance. Upon ascending, the positioning ball 41 will compress the spring 43. After that, the outer socket 30 is continuously rotated, so that when the engaging recess 35 of the outer socket 30 is aligned with the loading ball 45, the loading ball 45 will be biased toward the corresponding engaging recess 35 from the resisting surface 333 of the tooth 33 by the elastic force of the spring 43 and quickly engaged into the engaging recess 35, that is to say, the loading ball 45 is restricted in the space defined by the second side surface 332 of one of the teeth 33, the first side surface 331 of the neighboring tooth 33 and the ratchet surface 311 of the outer socket 30. Therefore, while the loading ball 45 quickly touches the second side surface 332 of the one of the teeth 33, the first side surface 331 of the neighboring tooth 33 and the ratchet surface 311 of the outer socket 30, the sound will thus be produced. As a result of this, when the torque achieves the predetermined value during the operation of the toque socket, the sound will be produced to warn the user that the torque applied to the fastener by the toque wrench has reached the predetermined value.

The torque socket in accordance with the present essentially comprises an outer socket, an inner socket, a spring, a positioning ball and a loading ball, so that the present invention is simple in structure. Especially, only one set of a positioning ball and a loading ball is needed, so the present invention is more convenient to assemble.

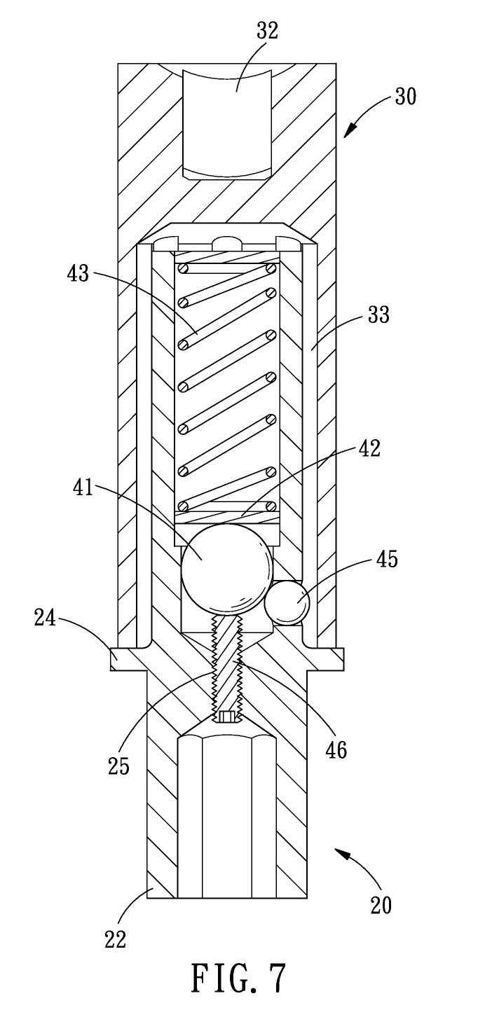

Referring to FIG. 7, when the user needs to adjust the torque applied to the fastener, the user can adjust the depth that the adjusting rod 46 is screwed into the adjusting hole 25 to control the compression extent of the spring 43. When the spring 43 is not compressed, the force which the user applies to the spring 43 to compress the spring 43 is the greatest torque which the spring 43 can bear. Thereby, the greater the compression extent of the spring 43 is, the greater the predetermined pressure will be, such that the force which makes the loading ball 45 move will be reduced, that is to say, the force for screwing the fastener will be smaller.

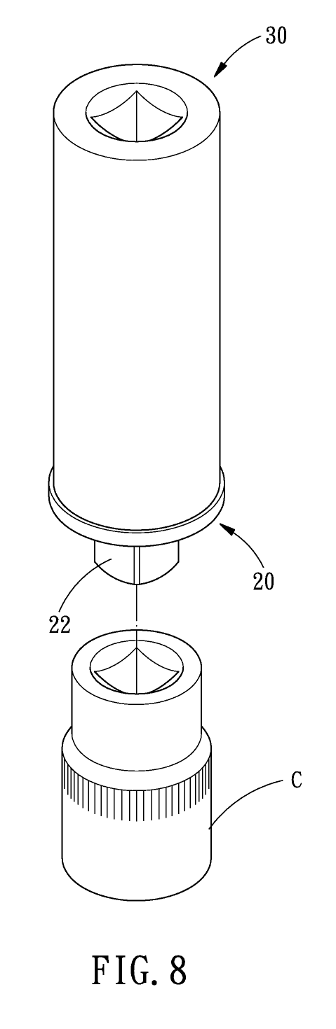

Referring to FIG. 8 showing a torque socket in accordance with a second embodiment of the present invention, the first assembling portion 22 of the inner socket 20 is a tetragonal column to be engaged into a sleeve C.

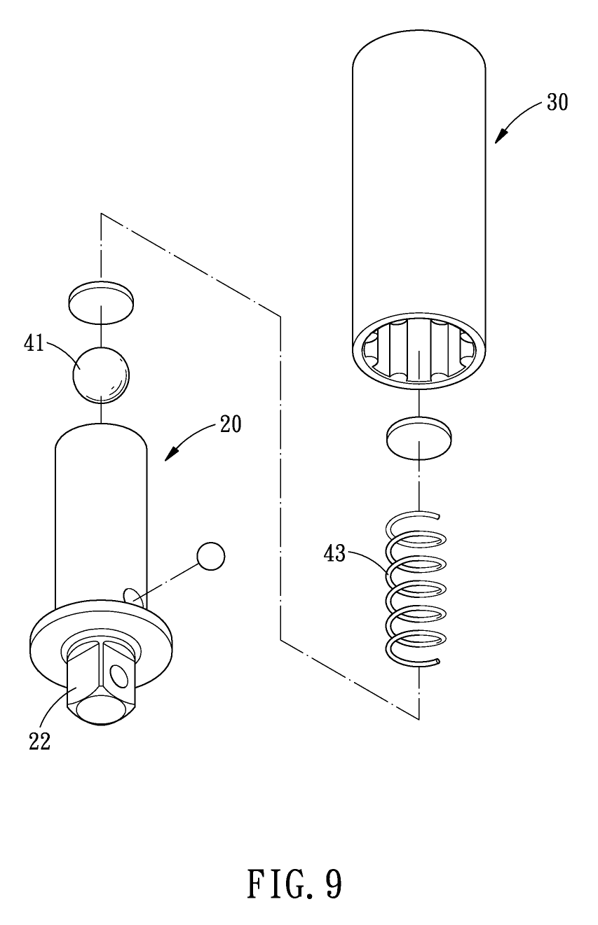

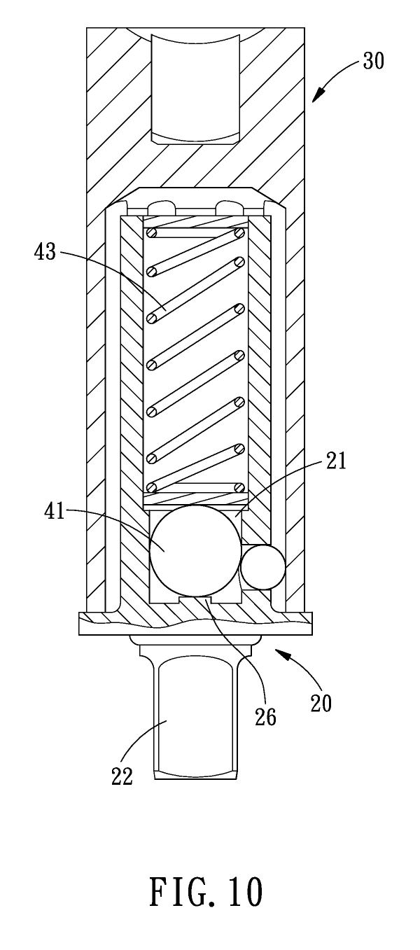

Referring to FIGS. 9 and 10 showing a torque socket in accordance with a third embodiment of the present invention, the first assembling portion 22 of the inner socket 20 is a tetragonal column. A protruding block 26 is disposed at a bottom of the recess 21 and abutted against the positioning ball 41. No adjusting rod is provided at the inner socket 20, such that the torque can only be controlled according to the elasticity coefficient of the spring 43.

While we have shown and described various embodiments in accordance with the present invention, it is clear to those skilled in the art that further embodiments may be made without departing from the scope of the present invention.

What is claimed is:

1. A torque socket comprising:
an inner socket being interiorly provided with an axially movable positioning ball, a spring and a radially movable loading ball, the positioning ball and the loading ball being pushed against each other, and the loading ball being allowed to partially protrude out of the inner socket; and
an outer socket axially including a holding groove in one end thereof, the holding groove of the outer socket being formed with a ratchet surface on an inner periphery thereof, on the ratchet surface being equidistantly provided plural annularly-arranged teeth, the respective teeth including two side surfaces, and a resisting surface connected between the two side surfaces, between two opposite side surfaces of each two neighboring teeth being formed a U-shaped engaging recess with respect to the ratchet surface, the outer socket being allowed to be pivotally engaged on the inner socket, when the loading ball is engaged into the one of the engaging recesses, the outer socket and the inner socket will be fixed relative to each other, when the loading ball is pushed against by one of the resisting surfaces of the teeth, the outer socket and the inner socket are allowed to pivot relative to each other;
by such arrangements, during a pivoting process of the inner socket and outer socket, the loading ball will move into and out of the inner socket due to its position changes with respect to the engaging recesses and the teeth, and when the loading ball passes over the teeth and engages into the engaging recess, a sound will be produced.

2. The torque socket as claimed in claim 1, wherein the inner socket axially includes a recess and a first assembling portion in two ends thereof, and the inner socket is axially defined with a through hole in communication with the recess, the recess is provided for accommodation of the positioning ball and the spring, the through hole is provided for accommodation of the loading ball.

3. The torque socket as claimed in claim 2, wherein an adjusting hole is defined between the recess and the first assembling portion of the inner socket, in the adjusting hole is disposed an adjusting rod, one end of the adjusting rod protrudes from the first assembling portion of the inner socket, and the other end of the adjusting rod is abutted against the positioning ball.

4. The torque socket as claimed in claim 3, wherein the outer socket is provided with a second assembling portion at the other end opposite the holding groove.

5. The torque socket as claimed in claim 4, wherein the second assembling portion of the outer socket is provided for engaging with a wrench.

6. The torque socket as claimed in claim 4, wherein the second assembling portion of the outer socket is provided for engaging with a gripping handle.

7. The torque socket as claimed in claim 2, wherein the first assembling portion of the inner socket is an inner hexangular groove.

8. The torque socket as claimed in claim 2, wherein the first assembling portion of the inner socket is an inner tetragonal groove.

9. The torque socket as claimed in claim 2, wherein the inner socket includes a flange extending outwards from a middle portion thereof for stopping against the outer socket.

10. The torque socket as claimed in claim 2, wherein a first stopper is disposed between the positioning ball and the spring, and a second stopper is disposed between the spring and the outer socket.

11. The torque socket as claimed in claim 3, wherein the adjusting hole is a threaded hole.

12. The torque socket as claimed in claim 11, wherein the adjusting rod is a screw.
